(19) United States
(12) Patent Application Publication
(10) Pub. No.: US 2004/0011097 A1
(43) Pub. Date: Jan. 22, 2004

(54) Electromechanical keyless entry system for storage devices

(76) Inventor: Edward S. Jeffers, Oklahoma City, OK (US)

Correspondence Address: EDWARD S. JEFFERS, P.O. BOX 950165, OKLAHOMA CITY, OK, 73195-0165, US

(21) Appl. No.: 10/199,373

(22) Filed: Jul. 18, 2002

(51) Int. Cl. E05B 47/00

(52) U.S. Cl. 70/279.1

(57) ABSTRACT

A device for storing and securing tools, parts, instrumentation, equipment and the like having locking hardware manipulated about a keyed lock, an improved remote entry system simply applied to current and out of production storage devices offering the convenience of keyless entry and the redundancy of standard keylock operation. The entry system has a lock assembly (349A) to which the original equipment manufacturer's rotating hardware (430X) is attached. The lock (349A) is coupled to an electromechanical actuator assembly (149) by a shifter assembly (249B) and together supported within a storage device (270X) by a pylon assembly (189A). Electromechanical operation and control is accomplished by a receiver (380V) powered by a battery (390V) and activated by a transmitter (382V). Manual locking and unlocking is effected by the use of a key (250V) replicating the operation prior to incorporation of this system.

### CROSS-REFERENCES TO RELATED APPLICATIONS

Not applicable.

### BACKGROUND

1. Field of Invention

This invention relates to electromechanical keyless entry systems for storage devices, specifically to such devices used for workstations, tool storage units, cabinets and the like.

2. Description of Prior Art

Originally storage devices allowed only the means of keyed locking systems for accessing and securing their contents. This singular means required the time and inconvenience associated with keyed locks. Inventors have addressed this discrepancy by the incorporation of mechanical combination keypads. Consequently, this approach has compromised security and has done little to save time. Subsequently, transmitter/receiver units with complicated manual operational design have been embodied to control drive mechanisms that manipulate the locking hardware of these devices. Yet, as in U.S. Pat. No. 6,116,067 to Myers, et al., Sep. 12, 2000 these later attempts employ complexity in design, manufacturing and installation and are model specific resulting in high production and maintenance costs with minimal market adaptability leaving several desirable objects unresolved. Heretofore, inventors have failed to provide users of storage devices with an economical keyless entry system, incorporating a practical redundant manual operational means, that is easily retrofitable to a wide variety of these devices. Users desiring these features, therefore, have been limited to the choice of an expensive upgrade for a select few models or complete replacement of their storage devices by one of a few models offering this convenient aspect.

### SUMMARY

In accordance with the present invention an electromechanical keyless entry system for storage devices comprises a keyed lock assembly, an electromechanical actuator, associated hardware connecting the lock to the actuator, an electronic control device activated by keyless means to electrically drive the actuator and a source to electrically power the control device and actuator unit.

### OBJECTS AND ADVANTAGES

Accordingly, in addition to the objects and advantages of the electromechanical keyless entry system for storage devices described in my above application, several objects and advantages of my invention are:

(a) to provide an economically manufactured electromechanical keyless entry system for storage devices;

(b) to provide an eletromechanical keyless entry system for storage devices with simplified construction requirements;

(c) to provide an electromechanical keyless entry system for storage devices with simplified installation proceedures;

(d) to provide a cost effective means of incorporating an electromechanical keyless entry system for storage devices with minimal redesign and retooling costs for original equipment manufacturers (OEMs);

(e) to provide OEMs of storage devices a vehicle with which to increase the appeal of their products in an affordable electromechanical keyless entry feature;

(f) to provide a product packaged in kit form facilitating the creation of an aftermarket of an affordable electromechanical keyless entry system for storage devices;

(g) to provide an electromechanical keyless entry system simply retrofitable to a wide variety of future, current and out of production storage devices;

(h) to provide an electromechanical keyless entry system that obviates the protection of the contents of storage devices by increased incidents of securing those contents via virtual simplicity and conveniene of doing so; and

(i) to provide an electromechanical keyless entry system for storage devices that features the added convenience of a practical redundant keyed lock operation.

Further objects and advantages of my invention are to provide an econimical electromechanical keyless entry system for storage devices, offering ease and convenience, when used in work environments that require a high level of security to reduce the risk of unauthorized use of their contents to accomplish terrorist and/or illegal acctivities. And yet further objects and advantages of my invention will become apparent from a consideration of the drawings and ensuing description.

### DRAWING FIGURES

In the drawings closely related figures have the same numbers with differing alpha suffixes.

FIGS. 1A and 1B are exploded perspective views of the basic components of the preferred embodiment of my entry system.

FIG. 2A is a detailed exploded perspective view of the portion 2A referenced in FIG. 1A.

FIG. 2B is an exploded view of the components of FIG. 2A illustrated from a different perspective.

FIG. 2C is a perspective view of a cylinder lock of my entry system as supplied by a vendor.

FIG. 2D is a perspective view in detail of the portion 2D refrenced in FIG. 2C.

FIG. 2E is a perspective view of the cylinder lock dipicted in FIG. 2C after modification.

FIG. 2F is a perspective sectional view in detail of the portion referenced by section line 2F-2F in FIG. 2A.

FIG. 2G is a prespective sectional view in detail of the portion referenced by section line 2G-2G in FIG. 2B.

FIG. 3A is an exploded perspective view of individual components of an actuator sub-assembly derived from components illustrated in FIG. 1A.

FIG. 3B is a perspective view of the assembled actuator sub-assembly of FIG. 3A.

FIG. 3C is an exploded perspective view of components of a standard clearance pylon sub-assembly derived from components illustrated in FIG. 1A.

FIG. 3D is a perspective view of the assembled pylon sub-assembly of FIG. 3C with the actuator sub-assembly of FIG. 3B in situ.

FIG. 3E is an exploded perspective view of components of a reduced clearance pylon sub-assembly derived from components illustrated in FIGS. 1A and 1B.

FIG. 3F is a perspective view of the assembled pylon sub-assembly of FIG. 3E with the actuator sub-assembly of FIG. 3B in situ.

FIG. 3G includes exploded perspective views of the components of three shifter sub-asemblies and assemblies derived from components illustrated in FIGS. 1A and 1B.

FIG. 3H includes perspective views of the assembled sub-assemblies and assemblies of FIG. 3G in various installation configurations of my entry system.

FIG. 3J includes exploded perspective views of the components of bellcranks and lock sub-assemblies and assemblies derived from components illustrated in FIGS. 1A and 1B.

FIG. 3K includes perspective views of the assembled bellcrank and lock sub-assemblies of FIG. 3J in various installation configurations of my entry system.

FIGS. 4A, 4B and 4C include orthogonal views depicting several sub-assembly and component combinitations and installation variation possibilities of my entry system.

FIGS. 5A through 5D are perspective views of one installation configuration posibility of my entry system when used on a storage device employing a hook cam type locking mechanism.

FIGS. 6A through 6D are perspective views of one installation configuration posibility of my entry system when used on a storage device employing a camshaft type locking mechanism.

FIGS. 7A and 7B are perspective views of one installation configuration posibility of my entry system when used on a storage device employing a cam and crankshaft type locking mechanism.

FIGS. 8A and 8B are perspective views of one installation configuration posibility of my entry system when used on a storage device employing a cantilever type locking mechanism.

FIGS. 9A through 9D are perspective views of yet additional installation configuration posibilities of my entry system when used on storage devices where reduced installation clearances are mandated.

### REFERENCE NUMERALS IN DRAWINGS

REF. # Nomenclature (Seen in FIG(S).)

[Components of Referenced Sub-Assembly or Assembly]

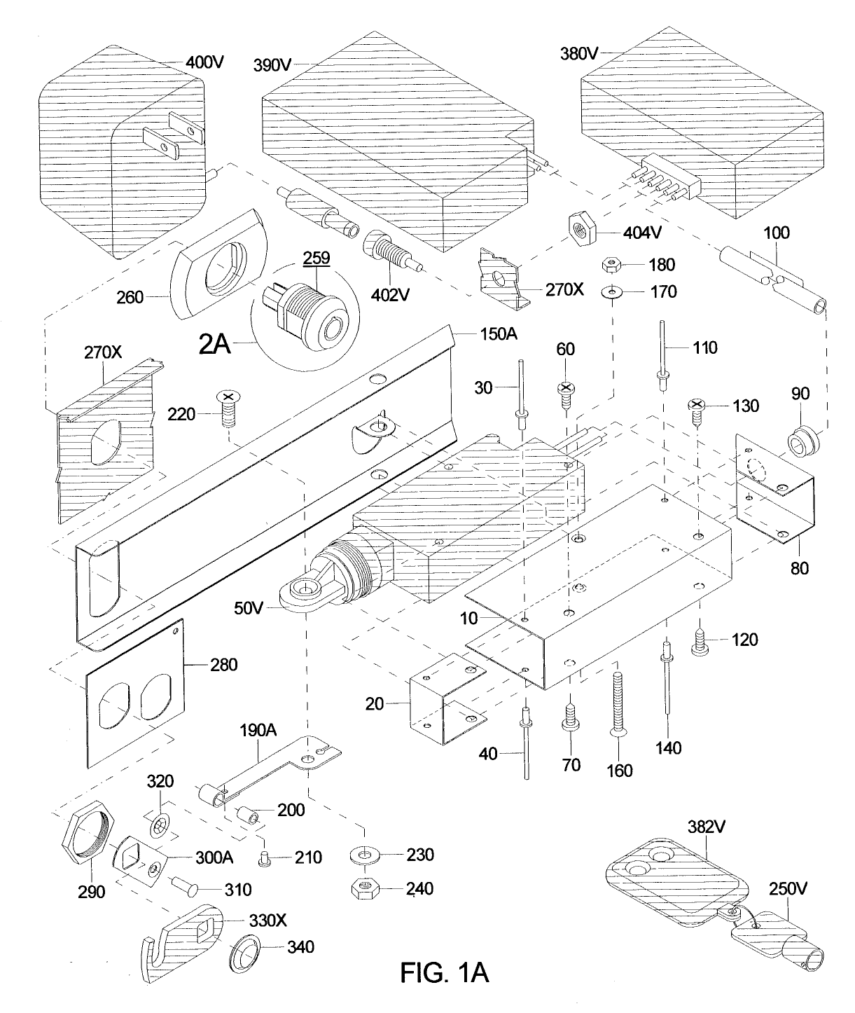

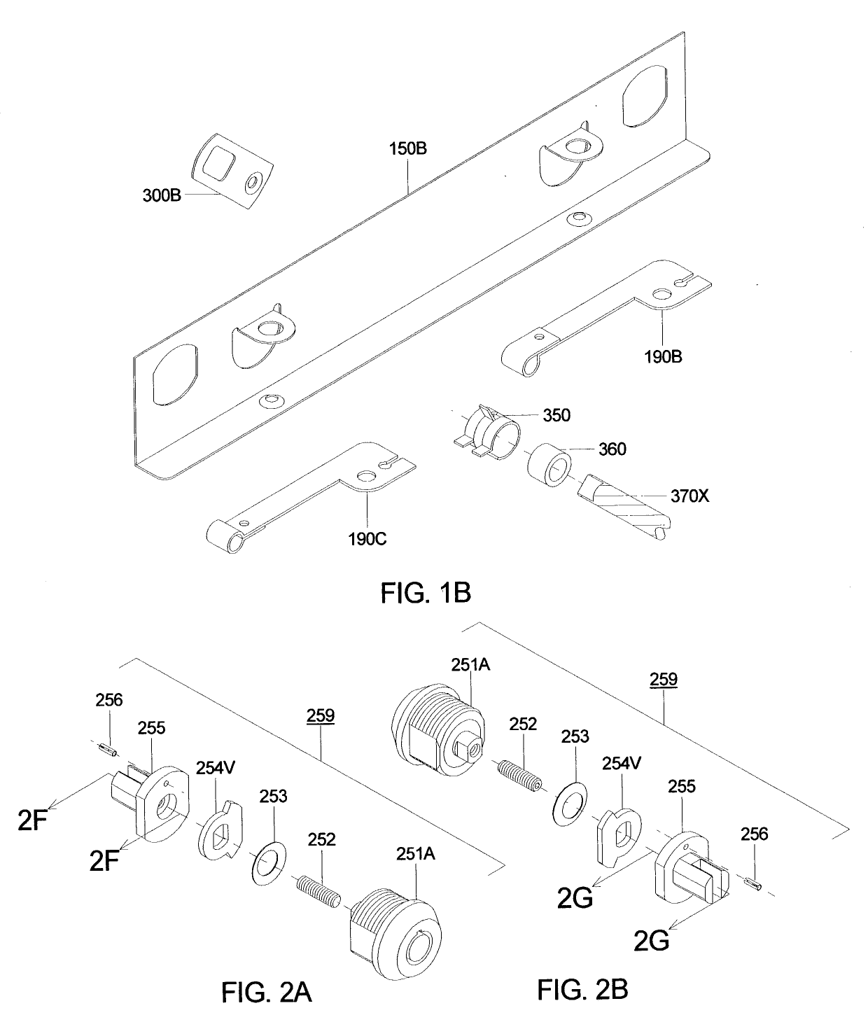

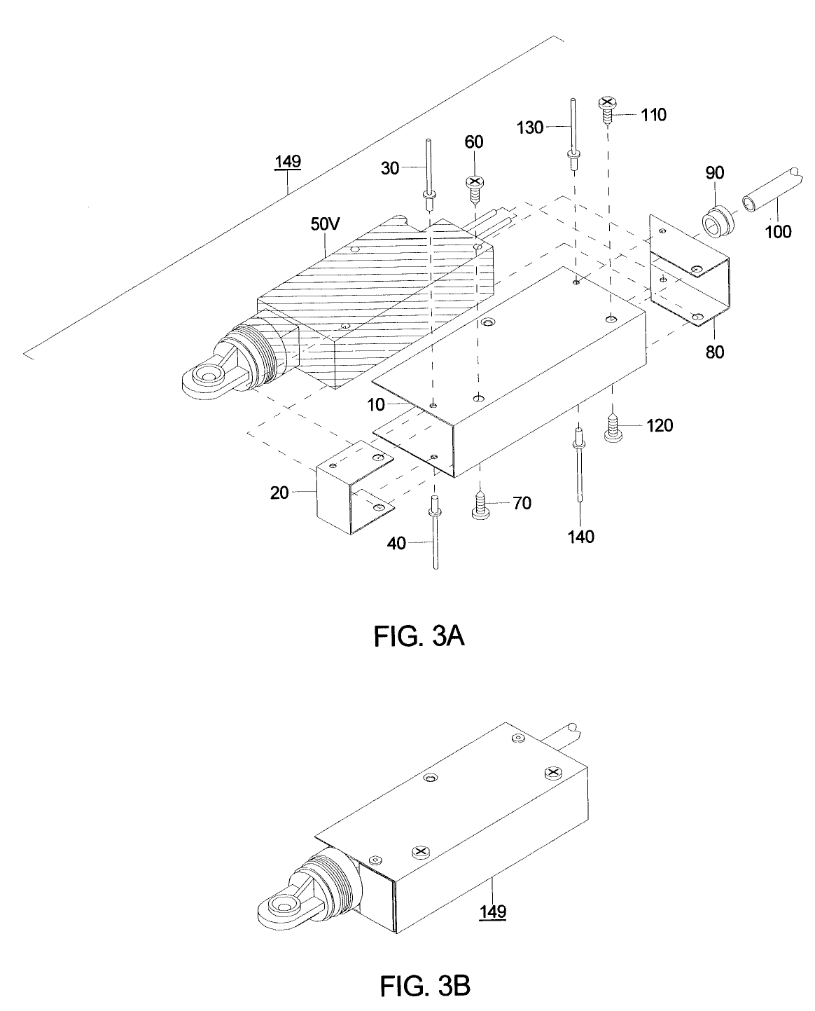

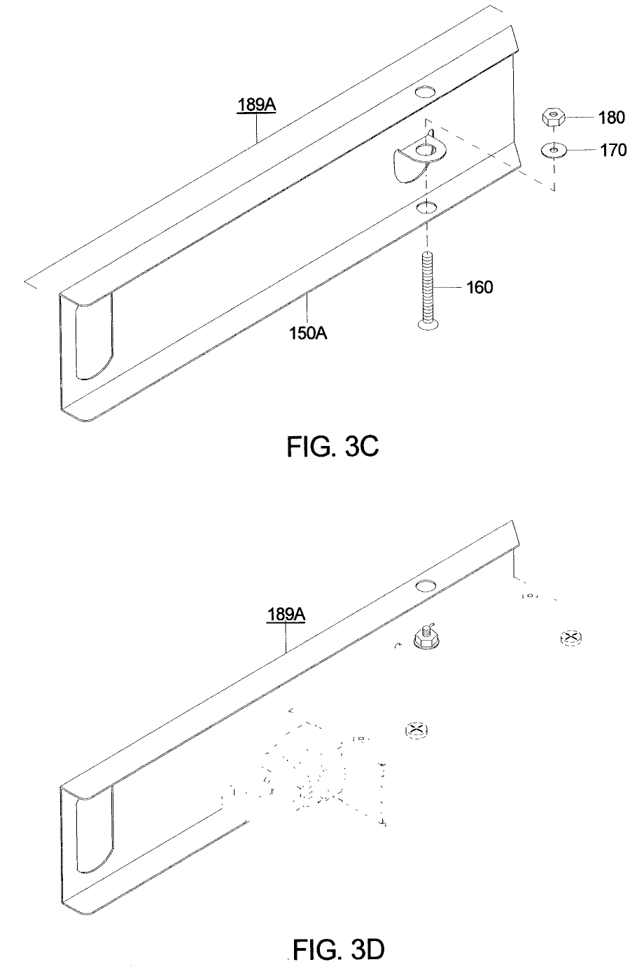

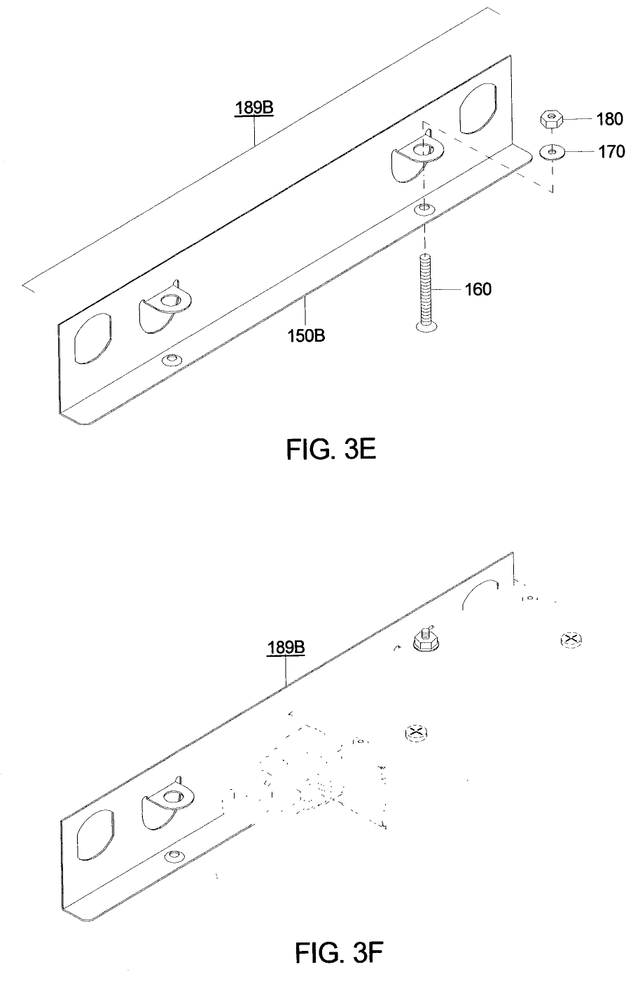

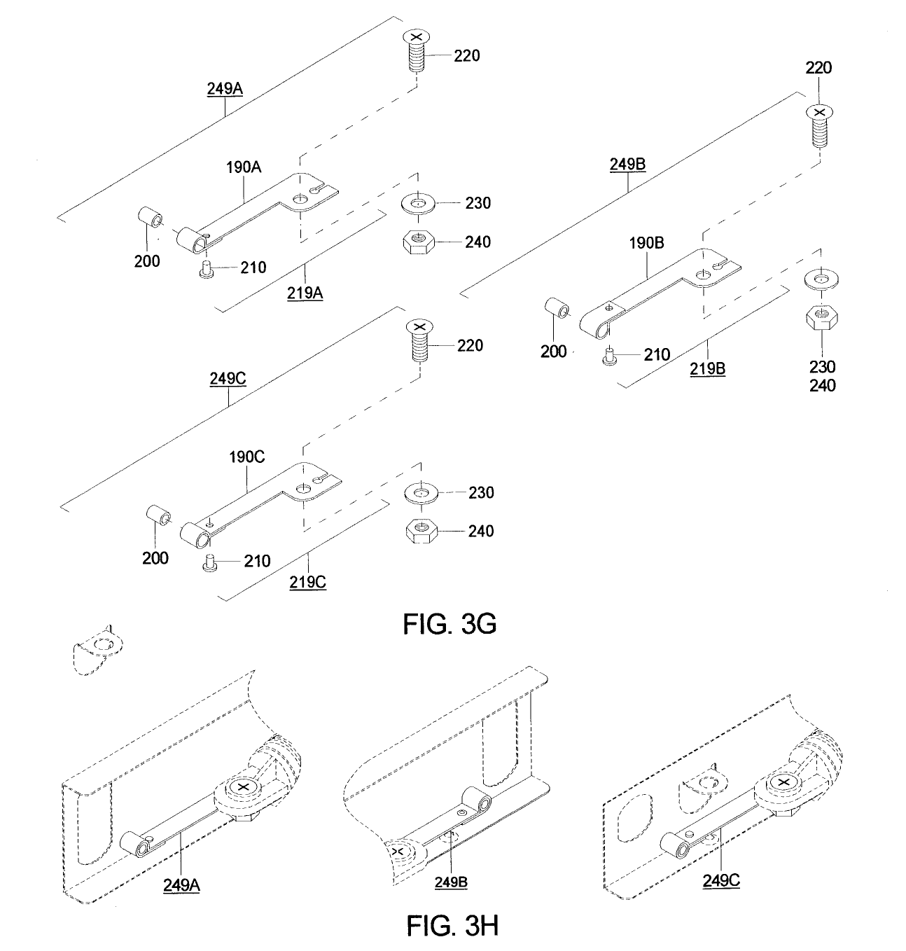

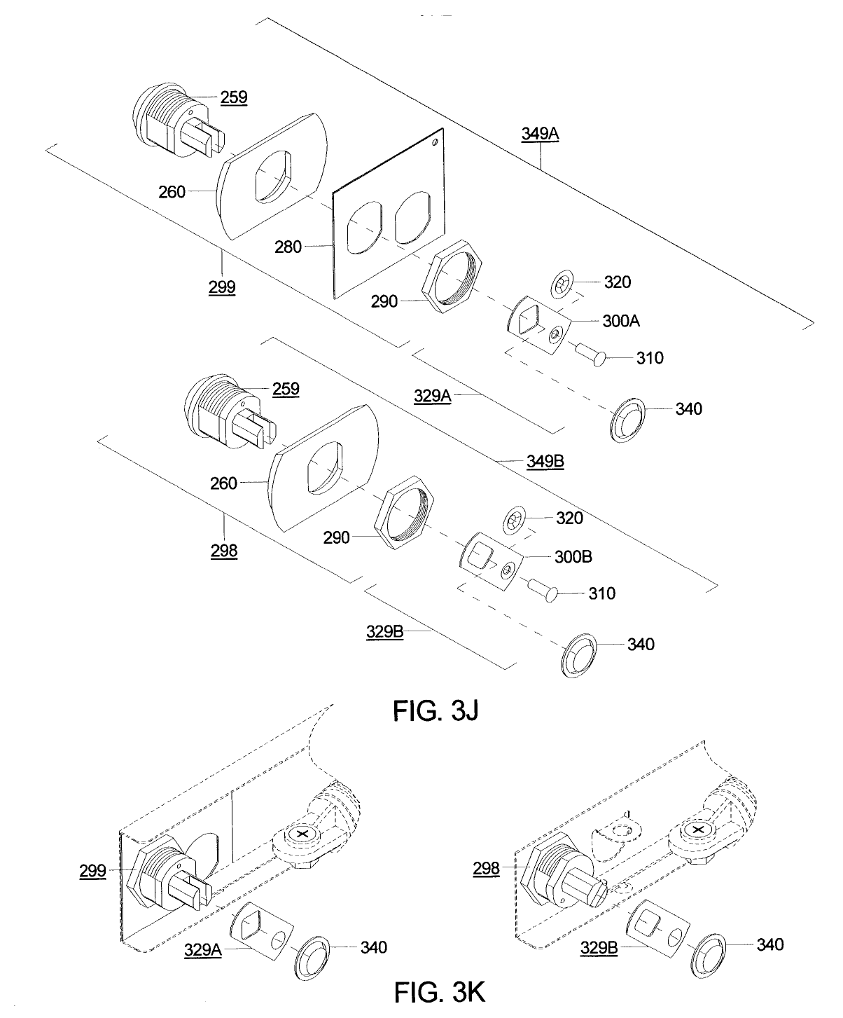

10 actuator shroud (FIGS. 1A and 3A)

20 actuator shroud cap (FIGS. 1A and 3A)

30 pull rivet (FIGS. 1A and 3A)

40 pull rivet (FIGS. 1A and 3A)

50V electromechanical lock actuator (FIGS. 1A, 3A, 4A, 4B and 4C)

60 self-tapping screw (FIGS. 1A and 3A)

70 self-tapping screw (FIGS. 1A and 3A)

80 actuator shroud feedthru (FIGS. 1A and 3A)

90 feedthru grommet (FIGS. 1A and 3A)

100 flexible conduit (FIGS. 1A and 3A)

110 self-tapping screw (FIGS. 1A and 3A)

120 self-tapping screw (FIGS. 1A and 3A)

130 pull rivet (FIGS. 1A and 3A)

140 pull rivet (FIGS. 1A and 3A)

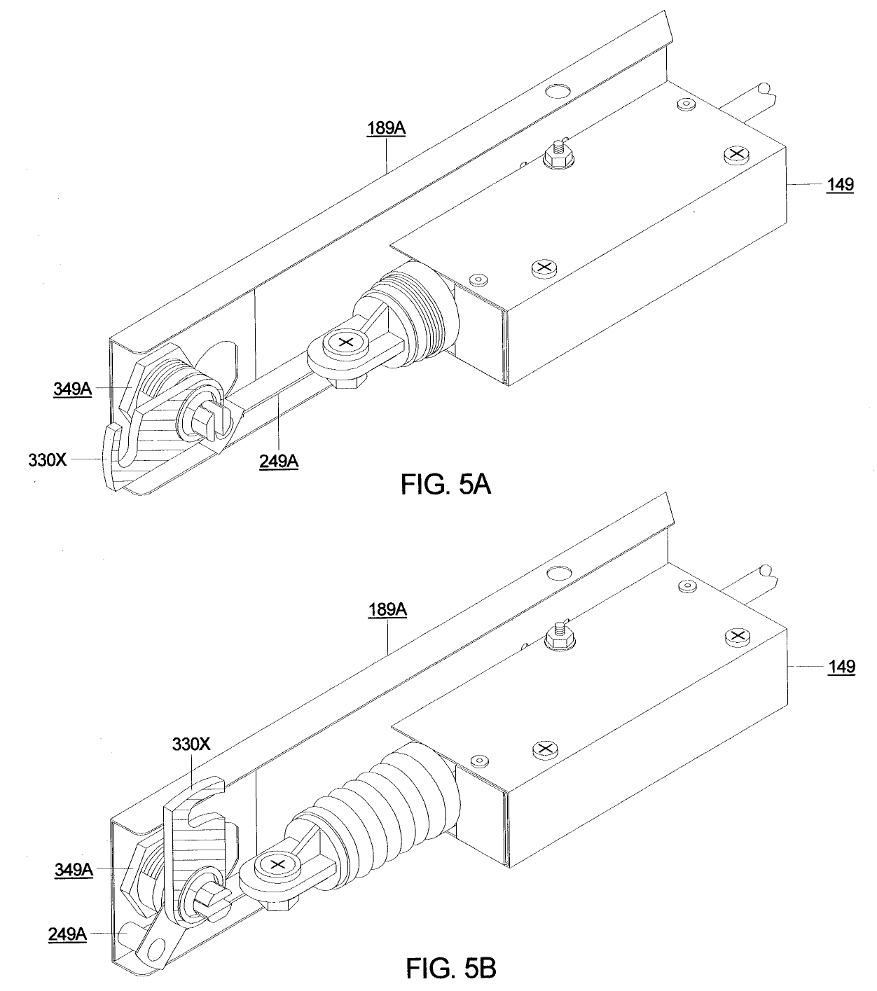

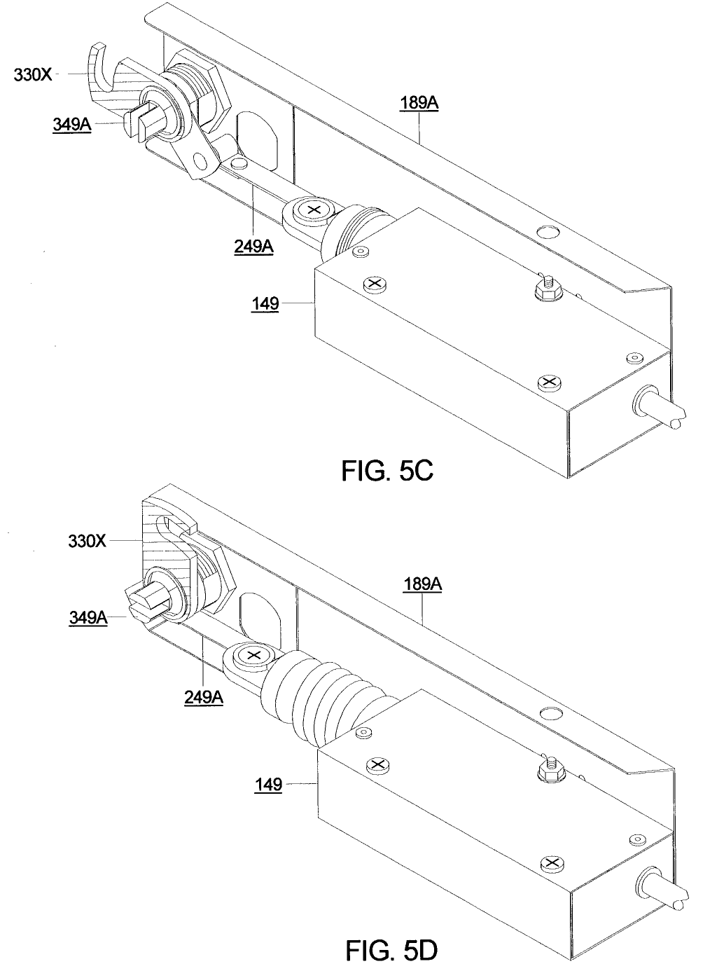

149 actuator sub-assembly (FIGS. 3B and 5A thru 9D)

[1 ea. #s 10, 20, 30, 40, 50, 60, 70, 80, 90, 100, 110, 120, 130, and 140]

150A standard clearance pylon (FIGS. 1A, 3C, 4A and 4B)

150B reduced clearance pylon (FIGS. 1B. 4C and 9A)

160 machine screw (FIGS. 1A, 3C, 3E and 9A)

170 flat washer (FIGS. 1A, 3C, 3E and 9A)

180 self-locking nut (FIGS. 1A, 3C, 3E and 9A)

189A standard pylon sub-assembly (FIGS. 3C, 3D and 5A through 8B)

[1 ea. #s 150A, 160, 170, and 180]

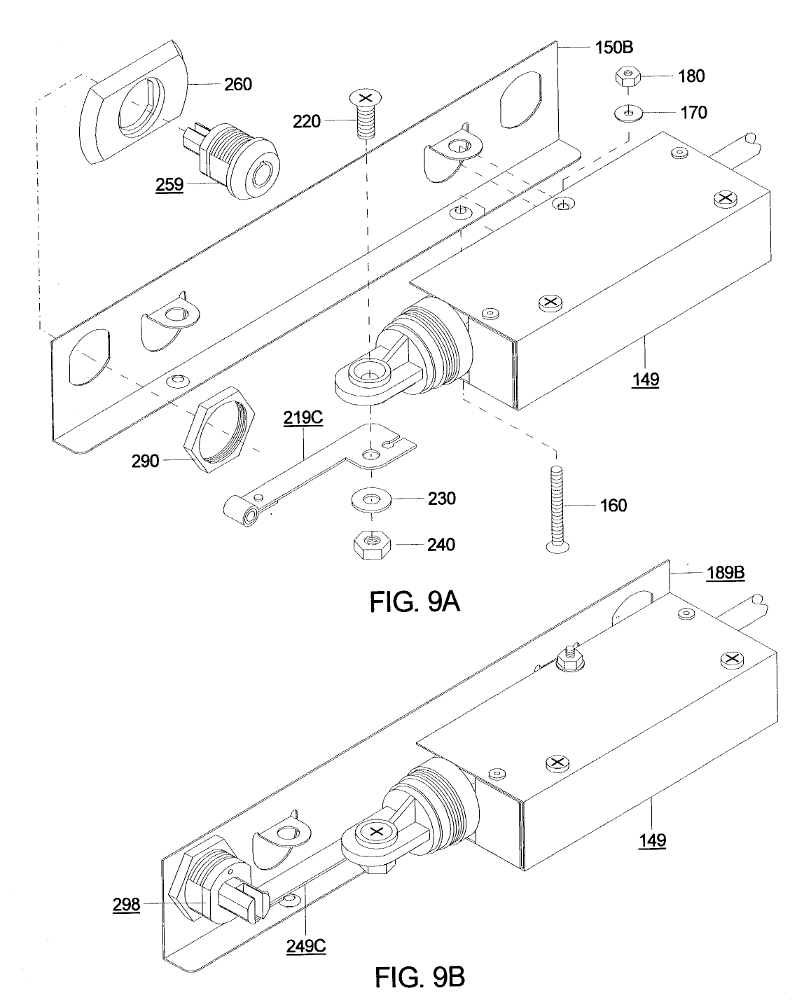

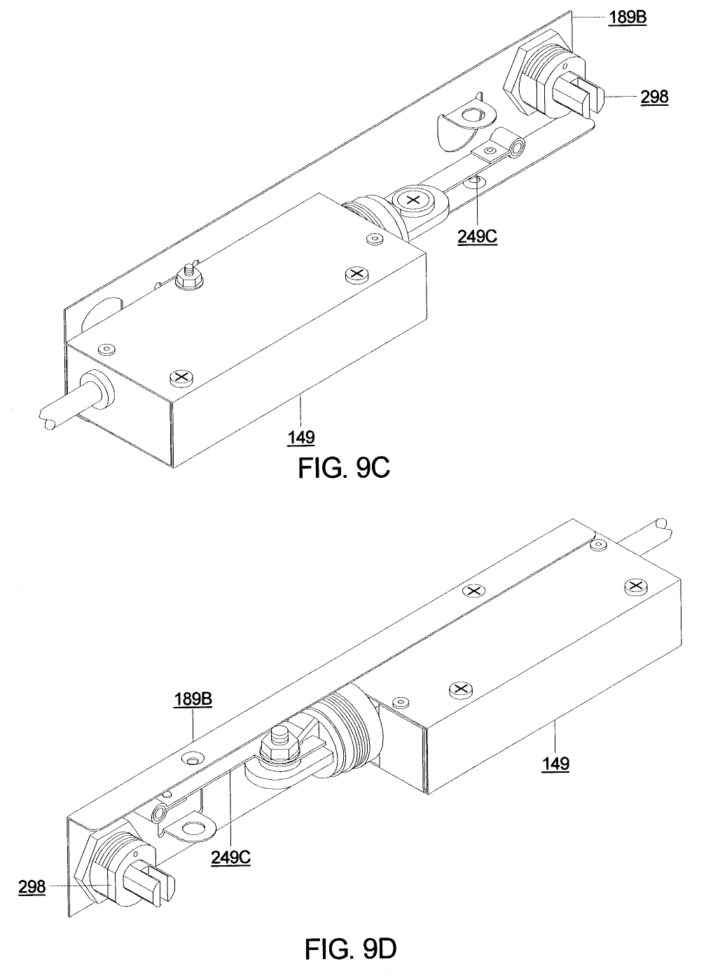

189B reduced clearance pylon sub-assembly (FIGS. 3E, 3F, 9B, 9C and 9D)

[1 ea #s 150B, 160, 170 and 180]

190A top lock shifter (FIGS. 1A and 3G)

190B bottom lock shifter (FIGS. 1B and 3G)

190C center lock shifter (FIGS. 1B and 3G)

200 plain bushing (FIGS. 1A and 3G)

210 solid rivet (FIGS. 1A and 3G)

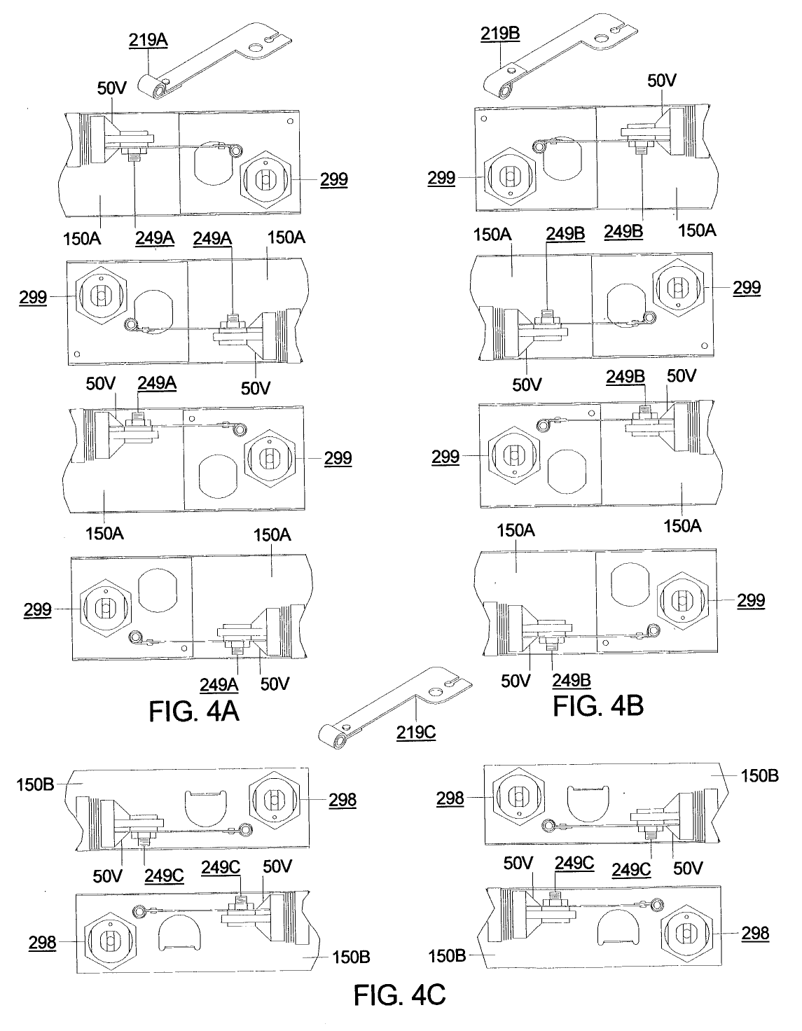

219A top lock shifter sub-assembly (FIGS. 3G and 4A)

[1 ea. #s 190A, 200 and 210]

219B bottom lock shifter sub-assembly (FIGS. 3G and 4B)

[1 ea. #s 190B, 200 and 210]

219C center lock shifter sub-assembly (FIGS. 3G, 4C and 9A)

[1 ea. #s 190C, 200 and 210]

220 machine screw (FIGS. 1A, 3G and 9A)

230 flat washer (FIGS. 1A, 3G and 9A)

240 self-locking nut (FIGS. 1A, 3G and 9A)

249A top lock shifter assembly (FIGS. 3G, 3H, 4A and 5A thru 7B)

[1 ea. #s 219A, 220, 230 and 240]

249B bottom lock shifter assembly (FIGS. 3G, 3H, 4B, 8A and 8B)

[1 ea. #s 219B, 220, 230 and 240]

249C center lock shifter assembly (FIGS. 3G, 3H, 4C, 9B, 9C and 9D)

[1 ea #s 219C, 220, 230 and 240]

250V key (FIG. 1A)

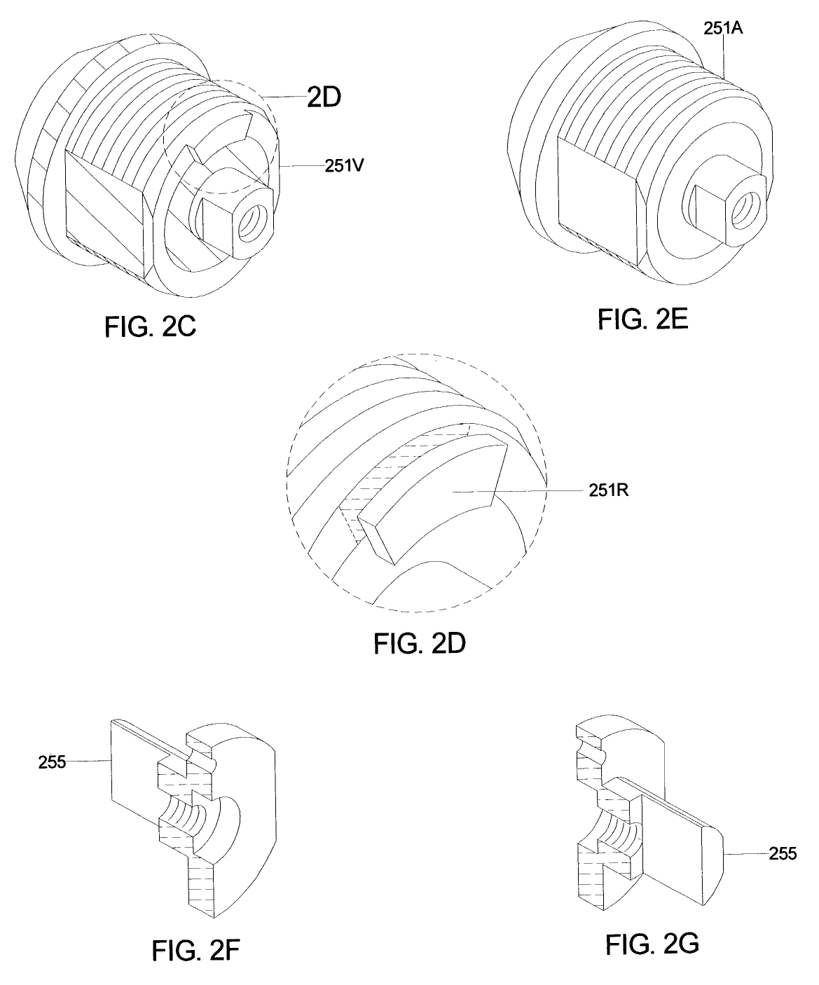

251A modified cylinder lock (FIGS. 2A, 2B and 2E)

251R cam stop land (FIG. 2D)

251V cylinder lock (FIG. 2C)

252 setscrew axle (FIGS. 2A and 2B)

253 spring washer (FIGS. 2A and 2B)

254 cam stop (FIGS. 2A and 2B)

255 lock cam hub (FIGS. 2A, 2B, 2F and 2G)

256 roll pin (FIGS. 2A and 2B)

259 cylinder lock assembly (FIGS. 1A, 2A, 2B, 3J and 9A)

[1 ea. #s 251A, 252, 253, 254V, 255 and 256]

260 lock bezel (FIGS. 1A, 3J and 9A)

270X OEM's storage device (FIG. 1A)

280 pylon indexer (FIGS. 1A and 3J)

290 hex nut (FIGS. 1A, 3J and 9A)

298 reduced clearance lock sub-assembly (FIGS. 3J, 3K, 4C, 9B, 9C and 9D)

[1 ea. # s 259, 260 and 290]

299 standard lock sub-assembly (FIGS. 3J, 3K, 4A, 4B and 6A)

[1 ea. #s 259, 260, 280 and 290]

300A 90 deg. shifter bellcank (FIGS. 1A and 3J)

300B 135 deg. shifter bellcrank (FIGS. 1B and 3J)

310 shifter shaft (FIGS. 1A and 3J)

320 shaft keeper (FIGS. 1A and 3J)

329A 90 deg. shifter bellcrank sub-assembly (FIGS. 3J and 3K)

[1 ea #s 300A, 310 and 320]

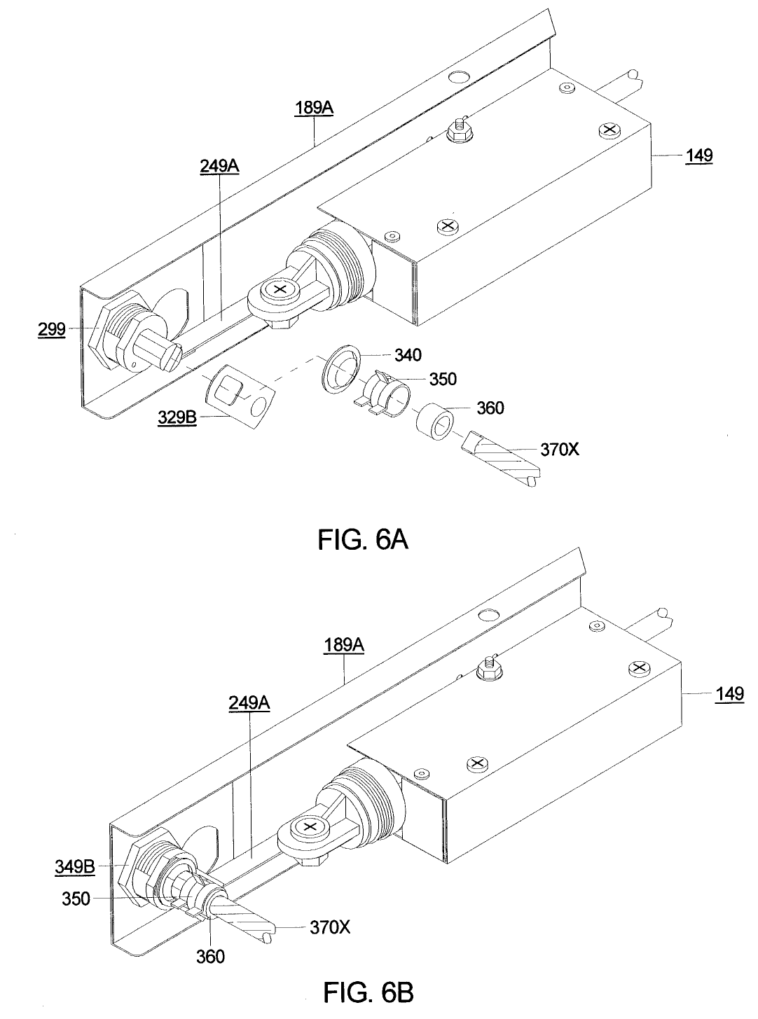

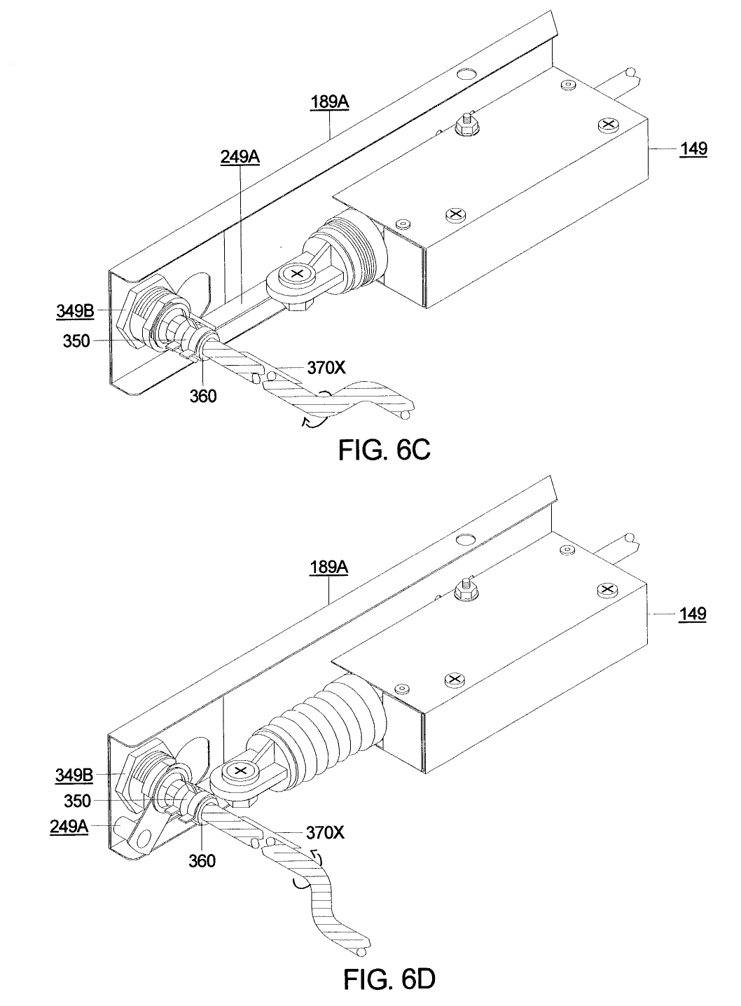

329B 135 deg. shifter bellcrank sub-assembly (FIGS. 3J, 3K and 6A)

[1 ea. #s 300B, 310 and 320]

330X OEM's locking mechanism hook cam (FIGS. 1A and 5A through 5D)

340 cam keeper (FIGS. 1A, 3J, 3K and 6A)

349A 90 deg. lock assembly (FIGS. 3J, 5A through 5D and 7A through 8B)

[1 ea. #s 298 or 299, 329A and 340]

349B 135 deg. lock assembly (FIGS. 3J, 6B, 6C and 6D)

[1 ea. #s 298 or 299, 329B and 340]

350 clamp (FIGS. 1B and 6A through 6D)

360 centering bushing (FIGS. 1B and 6A through 6D)

370X OEM's locking mechanism camshaft (FIGS. 1B and 6A through 6D)

380V control receiver (FIG. 1A)

382V control transmitter (FIG. 1A)

390V storage battery (FIG. 1A)

400V AC/DC converter (FIG. 1A)

402V electrical socket connector (FIG. 1A)

404V hex nut (FIG. 1A)

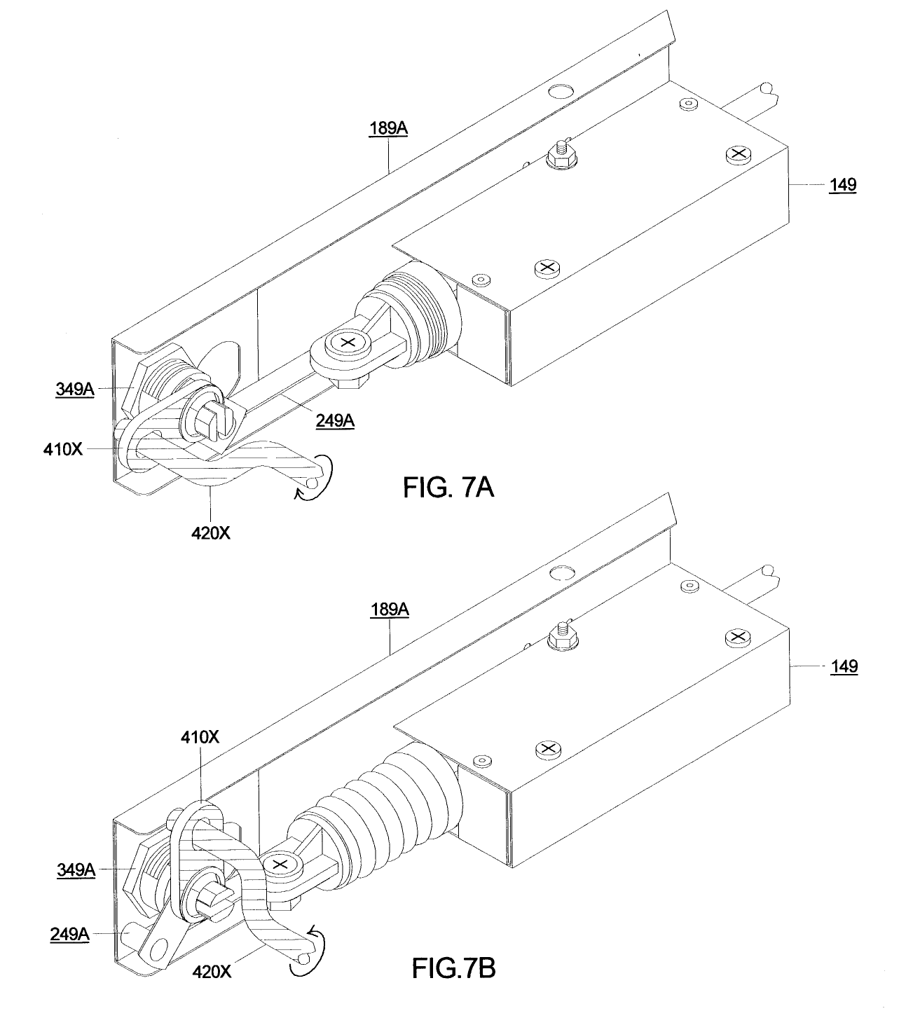

410X OEM's locking mechanism cam (FIGS. 7A and 7B)

420X OEM's locking mechanism crankshaft (FIGS. 7A and 7B)

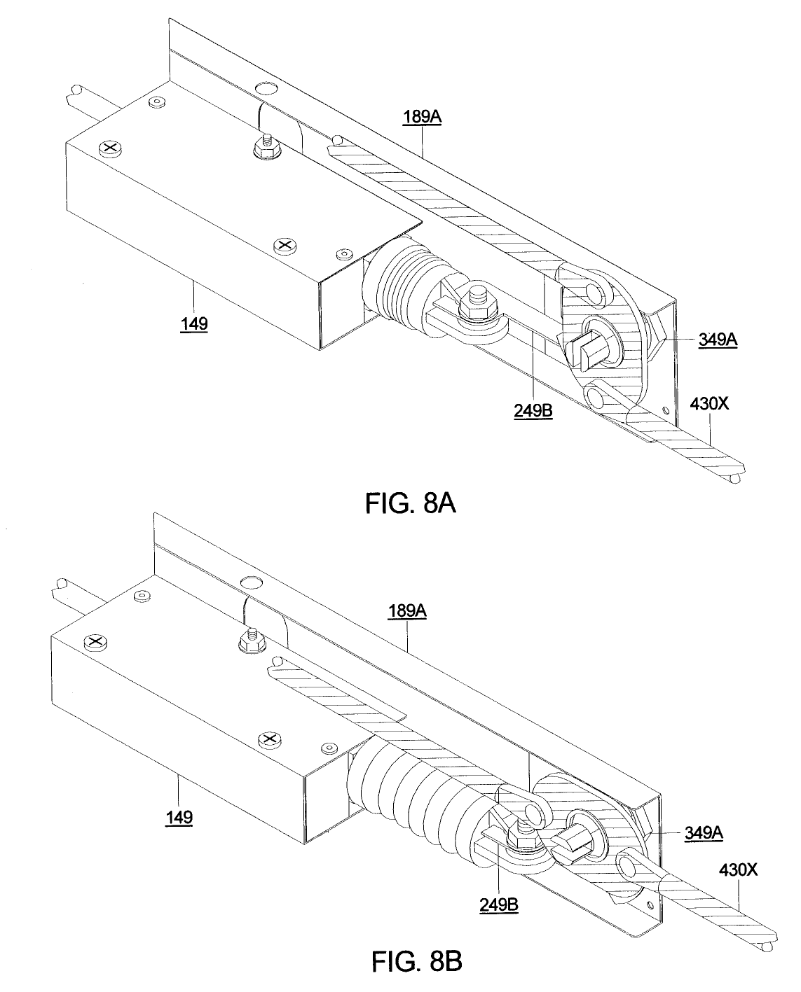

430X OEM's locking mechanism cantilever assembly (FIGS. 8A and 8B)

Description—FIGS. 1A and 1B—Preferred Embodiment

Exploded views of the components of the preferred embodiment of my electromechanical keyless entry system for storage devices are illustrated in FIGS. 1A and 1B. As seen in FIG. 1A the system has an actuator shroud 10, an actuator shroud cap 20 and an actuator shroud feedthru 80 fabricated from thin metal sheets. Shroud 10, cap 20 and feedthru 80 house and protect an industry standard automotive type electromechanical lock actuator 50V. A feedthru grommet 90 and a length of flexible conduit 100 are incorporated to protect the electrical wiring of actuator 50V. Pull rivets 30, 40, 110 and 140 secure cap 20 and feedthru 80 to shroud 10. Self-tapping screws 60, 70, 120 and 130 secure shroud 10 to actuator 50V. A standard clearance pylon 150A, constructed of a thin metal sheet, accepts and locates actuator 50V secured by a machine screw 160, a flat washer 170 and a self-locking nut 180. A top lock shifter 190A, constructed of thin spring tempered steel, accepts a plain bushing 200 affixed within shifter 190A via a solid rivet 210. Shifter 190A is fitted to the rod end of actuator 50V with a machine screw 220, a flat washer 230 and a self-locking nut 240. A cylinder lock assembly 259, manually operable with a key 250V, mates with a lock bezel 260, cast and/or machined of metal, which together mount through a storage device 270X's existing cylinder lock cutout. A pylon indexer 280, fabricated of a thin metal sheet, locates pylon 150A in relation to lock assembly 259 on the inner side of storage device 270X. Lock assembly 259, bezel 260, pylon 150A and indexer 280 are secured to storage device 270X via a hex nut 290. A shifter shaft 310 is inserted through a 90 deg. shifter bellcrank 300A, fabricated of a thin metal sheet, and secured by a shaft keeper 320. Bellcrank 300A is fitted onto the hub end of lock assembly 259 as bushing 200 receives shaft 310. A storage device 270X's original locking mechanism hook cam 330X is also positioned onto the hub end of lock assembly 259, a cam keeper 340 sandwiches and retains bellcrank 300A and cam 330X to lock assembly 259.

An industry standard automotive type keyless entry control receiver 380V, electronically activated by an accompanying control transmitter 382V, is electrically connected to actuator 50V. An industry standard storage battery 390V is electrically connected to receiver 380V. Also electrically connected to the receiver 380V and fitted through storage device 270X is an electrical socket connector 402V secured by a hex nut 404V. Provided is an AC/DC converter 400V for connecting to socket 402V.

Additional Components of my keyless entry system are depicted in FIG. 1B. A reduced clearance pylon 150B, also fabricated of a thin metal sheet, is embodied in lieu of the standard clearance pylon 150A and indexer 280 of FIG. 1A. Either a bottom lock shifter 190B or a center lock shifter 190C, also constructed of thin spring tempered steel, replace top shifter 190A of FIG. 1A in differing installations. A 135 deg. shifter bellcrank 300B, also of a thin metal sheet, is substituted for 90 deg. bellcrank 300A of FIG. 1A as required by the installation. A clamp 350 and a centering bushing 360 are included for use in centering and securing an OEM's locking mechanism camshaft 370X to the hub of cylinder lock assembly 259 of FIG. 1A.

FIGS. 2A Through 2G—Lock Assembly

Components of lock assembly 259 of FIG. 1A are represented in FIGS. 2A. through 2G. In FIGS. 2A and 2B, a setscrew axle 252 is threaded into the spindle of a modified cylinder lock 251A and secured with a metal to metal adhesive. A spring washer 253 and a cam stop 254V are situated over the spindle of lock 251A and sandwiched into lock assembly 259 by threading a lock cam hub 255, cast and/or machined of metal, fully onto axle 252 less approximately ½ turn, then to finalize the assembly a roll pin 256 is pressed into hub 255.

In FIG. 2C an industry standard multifunction cam lock 251V is transformed into modified lock 251A of FIGS. 2A, 2B and 2E by machining from its shell a cam stop land 251R represented in FIG. 2D.

FIGS. 2F and 2G further illustrate hub 255 as sectioned in FIGS. 2A and 2B.

FIGS. 3A and 3B—Actuator Assembly

The components of FIG. 3A assembled constitute the actuator sub-assembly 149 represented in FIG. 3B. In FIG. 3A, cap 20 is placed within shroud 10 and secured in place with rivets 30 and 40. Actuator 50V is then placed within shroud 10 and partially secured by screws 60 and 70. Grommet 90 is inserted into feedthru 80 and receives conduit 100 secured by an appropriate adhesive. Feedthru 80 is next placed within shroud 10, encompassing actuator 5V, as its wiring is directed through conduit 100, and secured with screws 110 and 120 and finally rivets 130 and 140.

FIGS. 3C Through 3F—Pylon Assembly

FIGS. 3C through 3F show two possible pylon sub-assembly configurations. Pylons 150A and 150B, screws 160, washers 170 and nuts 180 of FIGS. 3C and 3E assembled represent pylon sub assemblies 189A and 189B shown in FIGS. 3D and 3F respectively.

FIGS. 3G and 3H—Shifter Assembly

FIGS. 3G and 3H depict shifter sub-assemblies, assemblies and some typical installations. Shifters 190A, 190B and 190C, bushings 200 and rivets 210 of FIG. 3G assembled produce top, bottom and center lock shifter sub-assemblies 219A, 219B and 219C. Sub-assemblies 219A, 219B and 219C combined with screws 220, washers 230 and nuts 240 of FIG. 3G represent top, bottom and center lock shifter assemblies 249A, 249B and 249C as shown typically installed in FIG. 3H.

FIGS. 3J and 3K—Bellcrank and Lock Assemblies

FIGS. 3J and 3K exhibit various bellcrank and lock assemblies and sub-assemblies in some typical installations. Lock assembly 259, bezel 260 and nut 290 makeup a reduced clearance lock sub-assembly 298 in FIG. 3J. Adding indexer 280 to sub-assembly 298 renders a sub-assembly 299, also seen in FIG. 3J. In assembling bellcranks 300A and 300B with shafts 310 and keepers 320, sub-assemblies 329A and 329B are created and represented in FIG. 3K. Combining sub-assemblies 298 or 299 with the sub-assembles 329A or 329B and keeper 340 produces lock assemblies 349A and 349B as shown in FIG. 3K.

FIGS. 4A, 4B and 4C—Installation Configurations

In FIGS. 4A, 4B and 4C several installations with varying assembly and sub-assembly configurations are figured to illustrate a multitude of application possibilities. FIG. 4A demonstrates installation possibilities incorporating the use of standard pylon 150A in combination with shifter sub-assembly 219A. Additional applications illustrated in FIG. 4B mirror those of FIG. 4A by the use of shifter sub-assembly 219B. Pylon 150B combined with the use of shifter sub-assembly 219C further illustrate additional installation possibilities in FIG. 4C.

FIGS. 5A Through 5D—Typical Hook Cam Application

FIGS. 5A through 5D typify my keyless entry system in an application that employs an OEM's hook cam type locking mechanism. The system is assembled to include actuator sub-assembly 149, pylon sub-assembly 189A, shifter assembly 249A, lock assembly 349A and the OEM's cam 330X. The system is illustrated in the unlocked position in FIGS. 5A and 5C, and the locked position in FIGS. 5B and 5D.

FIGS. 6A Through 6D—Typical Camshaft Application

FIGS. 6A through 6D typify my keyless entry system in an application that employs an OEM's camshaft type locking mechanism. The system is assembled, in FIG. 6A, to include actuator sub-assembly 149, pylon sub-assembly 189A, shifter assembly 249A, lock sub-assembly 299, bellcrank sub-assembly 329B, keeper 340, clamp 350, bushing 360 and the OEM's camshaft 370X. Lock sub-assembly 299, bellcrank sub-assembly 329B and keeper 340 are joined and represented by lock assembly 349B in FIGS. 6B, 6C and 6D. The system is illustrated in the locked and the unlocked positions in FIGS. 6C and 6D, pursuant to the OEM's installation.

FIGS. 7A and 7B—Typical Cam and Crankshaft Application

FIGS. 7A and 7B typify my keyless entry system in an application that employs an OEM's cam and crankshaft type locking mechanism. The system is assembled to include actuator sub-assembly 149, pylon sub-assembly 189A, shifter assembly 249A, lock assembly 349A, and with a cam and a crankshaft 410X and 420X of the OEM's locking mechanism. The system is illustrated in the locked and the unlocked positions pursuant to the OEM's installation.

FIGS. 8A and 8B—Typical Cantilever Application

FIGS. 8A and 8B typify my keyless entry system in an application that employs an OEM's cantilever type locking mechanism. The system is assembled to include actuator sub-assembly 149, pylon sub-assembly 189A, shifter assembly 249B, lock assembly 349A, and a cantilever assembly 430X of the OEM's locking mechanism. The system is illustrated in the unlocked position in FIG. 8A and the locked position in FIG. 8B.

FIGS. 9A Through 9D—Reduced Clearance Application

FIGS. 9A through 9D typify my keyless entry system in several applications where the OEM's installations require reduced clearances. FIG. 9A illustrates actuator sub-assembly 149 and components of pylon sub-assembly 189B, shifter assembly 249C and lock sub-assembly 298 assembled and represented in FIGS. 9B, 9C and 9D. As shown in FIG. 9A actuator sub-assembly 149 is fitted and secured to pylon 150B by screw 160, washer 170 and nut 180. Also, shifter sub-assembly 219C is affixed onto the rod end of actuator sub-assembly 149 with screw 220, washer 230 and nut 240. Lock assembly 259 then passes through bezel 260 and into the OEM's storage device lock cutout. Finally the aforementioned assembled components are situated into the storage device and onto lock assembly 259 and secured by nut 290. The application of FIG. 9C is shown in FIG. 9D from another perspective.

Advantages

From the description above, a number of advantages of my keyless entry system become evident:

(a) Very few locally manufactured parts are needed for my keyless entry system. The manufacturing processes required are common and non-complicated techniques. Capital expenditure in this endeavor is minimal.

(b) OEM's can incorporate my keyless entry system into their products with little more than simple assembly line procedure changes.

(c) User installation of my keyless entry system is a quick and simple task requiring only common hand tools.

(d) My keyless entry system is easily retrofittable to a multitude of widely used storage devices by basically replacing only the lock cylinder, the original remainder of the OEM's locking mechanism remains incorporated and unchanged.

(e) My keyless entry system affords a large user base to realize the convenience of these features without the extreme expense of upgrades or replacements now available.

(f) My keyless entry system also economically provides increased protection of investments in equipment and their illegal and/or unauthorized use by simple exploitation of the added ease and convenience provided by a system of this type.

(g) My keyless entry system may be packaged and offered to the public in kit form and to OEMs with model specific design features in bulk thus reducing costs of incorporating this system into their production lines.

Operation

The operation of my electromechanical keyless entry system for storage devices is best understood if the existing locking mechanisms of these devices are considered. In most cases a common cylinder type keyed lock is incorporated to manipulate hardware by transforming the rotational movement of the lock's spindle to lift, push, pull or otherwise manipulate this hardware to lock and render unlocked these devices.

To accomplish the objectives of my entry system the OEM's cylinder lock is replaced with a lock that permits independent rotational travel of the hardware, originally affixed to and rotated with the lock's spindle, regardless of key insertion. In conjunction with the above a means is provided to accomplish this rotation electromechanically while maintaining the ability to perform this function manually.

Referring to FIGS. 2A and 2B, such a lock assembly is applied. In these illustrations lock assembly 259 is comprised of modified lock 251A into which axle 252 is completely threaded with the application of an appropriate adhesive to bond the two. Spring washer 253 is situated over the outer periphery of the spindle of lock 251A. Cam stop 254V, supplied with lock 251V, is next positioned and indexed onto the spindle of lock 251A. The flanged end of hub 255, sectioned in FIGS. 2F and 2G, is now threaded onto the protruding remainder of axle 252 until contacting cam stop 254V. Hub 255 then is reversed approximately ½ turn to facilitate insertion of roll pin 256 into and extending through the cylindrical passage in the flange of hub 255 occupying the void of the outer periphery of cam stop 254V. Hub 255 will now freely rotate approximately 215 degrees, restricted by roll pin 256 contacting cam stop 254V which is held fast onto the locked spindle of lock 251A and biased against the flange face of hub 255 by spring washer 253. Inserting and rotating key 250V of FIG. 1A will now rotate hub 255. As cam stop 254V and the spindle of lock 251A rotate with key 250V cam stop 254V engages roll pin 256, which carries the rotational movement to hub 255.

Implementing the features of a lock of this type requires the use of an electromechanical actuator and associated hardware connecting the two. In accordance with the OEM's hardware configuration an installation, see FIGS. 4A, 4B and 4C, is chosen. For the purpose of this discussion the installation in accordance with the bottom configuration of FIG. 4A shall be described. Individual components referenced and not underlined and including lock assembly 259 may be found in FIGS. 1A and 1B. Figures representing other components, assemblies and sub-assemblies in the following description shall be referenced as they are described.

Lock assembly 259 is fitted and indexed into bezel 260 and together placed onto the OEM's 270X storage device with the threaded end of lock 259 occupying its lock cutout. Actuator sub-assembly 149 of FIG. 3B is joined to pylon sub-assembly 189A of FIG. 3C as depicted in FIG. 3D, then together located onto lock assembly 259 from the inside of device 270X. Indexer 280 is next located onto lock assembly 259 within pylon sub-assembly 189A with its orientation indicator at the bottom right as seen in the referenced configuration of FIG. 4A. Nut 290 threaded onto lock 259 now secures the above components in the required proximity to one another and the OEM's storage device.

Transforming the linear reciprocating movement of actuator 50V to the required rotational movement of hub 255, of FIG. 2A, is accomplished with the use of shifter assembly 249A of FIGS. 3G and 3H in conjunction with bellcrank sub-assembly 329A of FIG. 3K. Shifter assembly 249A attaches to the rod end of actuator 50V by screw 220, washer 230 and nut 240. Bellcrank sub-assembly 329A is positioned onto hub 255 as bushing 200 receives shaft 310. Extending or retracting the rod of actuator 50V now transmits the travel required to rotate hub 255. Hub 255 is biased stationary by the spring temper of shifter 190A at either extreme of actuator 50V's travel. As hub 255 transitions between these extremes of rod end travel its rotation is geometrically limited to ninety degrees while the downward displacement of shifter 190A at bushing 200 creates the spring bias. The OEM's cam 330X is fitted onto hub 255, in the proper orientation to replicate the OEM's locking mechanism operation, and secured with keeper 340.

Control of the system may now be accomplished manually or electromechanically. The redundant manual operation is effected by the use of a key, while the electromechanical manipulation employs the use of the actuator in conjunction with an industry standard automotive type keyless entry receiver and transmitter control device. The actuator and receiver are electrically sourced by an industry standard storage battery, which may be periodically recharged by a standard AC/DC converter.

Receiver 380V is located and conventionally secured within storage device 270X to which the wiring of actuator 50V is connected. Battery 390V is also located and secured within storage device 270X and electrically connected to receiver 380V. Connector 402V, received by storage device 270X and secured by nut 404V, provisions recharging of battery 390V. Converter 400V is provided to recharge battery 390V when connected between a standard AC outlet and connector 402V. As transmitter 382V is activated receiver 380V momentarily supplies electrical power to actuator 50V with one command and reverses the polarity of that power with the opposite command. This will effectively rotate hub 255 and the associated hardware, locking the device in one direction and unlocking the device in the opposite direction. Redundant manual duplication of this locking and unlocking is accomplished by inserting key 250V into lock assembly 259 and turning.

Operation of my keyless entry system may be further visualized in the representations of its use with various OEM's typical locking mechanisms.

In FIGS. 5A through 5D my entry system is shown as assembled above and as if incorporated into an OEM's storage device employing a hook cam type locking mechanism. In this installation FIGS. 5A and 5C represent the device in an unlocked state while FIGS. 5B and 5D show the device in a locked state.

In FIGS. 6A through 6D my entry system is shown as if incorporated into an OEM's storage device employing the use of a camshaft type locking mechanism. In this type of application most OEMs use a lock with the key removable at the 6 and 12 o'clock positions, one being locked and the other unlocked. Approximately the first and last 45 degrees rotation of the lock is wasted travel in that effective hardware manipulation is accomplished during the approximate middle 90 degrees of the 180 degree key rotation. Therefore bellcrank sub-assembly 329B is used for this application in lieu of bellcrank sub-assembly 329A, in that its hub cutout is rotated 45 degrees allowing the wasted travel to be consumed by the installation.

In FIG. 6A hub 255 is rotated this first 45 degrees in order to accommodate bellcrank sub-assembly 329B secured by keeper 340. Clamp 350 and bushing 360 are fitted onto the OEM's camshaft 370X which is then rotated its first 45 degrees travel, to consume the wasted movement, and mated into the slot of hub 255. Bushing 360 is located along camshaft 370X toward and until flush against hub 255. Clamp 350 is next located as to partially encompass both hub 255 and bushing 360 securing camshaft 370X to hub 255 with a common axis as shown in FIG. 6B. Illustrated in FIGS. 6C and 6D this application is assembled and in the locked and unlocked positions pursuant to the OEM's installation.

In FIGS. 7A and 7B my entry system is illustrated as if incorporated into an OEM's storage device employing a cam and crankshaft type locking mechanism. In this type application most OEMs use a lock allowing 90 degrees travel, otherwise the operation of this locking mechanism basically duplicates that of the system of FIGS. 6C and 6D. This installation differs only from the hardware configuration of FIGS. 5A through 5D by the use of the OEM's cam 410X and crankshaft 420X in place of hook cam 330X.

FIGS. 8A and 8B further illustrate my entry system as if incorporated into an OEM's storage device when a cantilever type locking mechanism is employed. In accordance with the configuration of the 2^{nd} illustration of FIG. 4B, and duplicating the installation and operation of FIGS. 5A through 5D, 7A and 7B, this application differs only with the use of bottom shifter 249B in lieu of top shifter 249A and the OEM's cantilever assembly 430X in place of the previously referenced locking mechanism hardware.

In addition reduced clearance pylon 150B could be used in lieu of pylon 150A and indexer 280 where an OEM's storage device restricts the allowable dimensions for installation. The remaining hardware configuration possibilities and operation would be unchanged from those explained above. In accordance with configurations illustrated in FIG. 4C a multitude of installations of this type are depicted in the illustrations of FIGS. 9A through 9D.

Conclusion, Ramifications and Scope

Accordingly, the reader will see that the electromechanical keyless entry system of this invention is economically applied to newly manufactured equipment as well as a wide variety of storage devices now in use. The simplicity of operation and incorporation of this keyless entry system is also evidenced. In addition, the design features of this keyless entry system offer reliability as well as ease in construction. Furthermore, the keyless entry system has additional advantages in that

it provides end users an affordable keyless entry system with neither having to expensively upgrade nor replace their present equipment to realize the benefits of keyless entry;

it creates a large aftermarket for an economical electromechanical keyless entry systems for storage devices by being kitable and retrofitable to a wide variety of devices;

it provides increased security to protect the user's investments represented by the items stored in their devices due to the virtual simplicity of increased incidents of locking these devices;

it provides a keyless entry system with a practical means of redundant manual key operation;

it provides users of storage devices employed in workplaces requiring increased vigilance, to reduce the risk of unauthorized use of stored equipment to accomplish terrorist and/or illegal activities, an economical means of realizing the convenience of keyless entry.

Although the descriptions above contain much specificity, these should not be construed as limiting the scope of the invention but as merely providing illustrations of some of the presently preferred embodiments of this invention. For example, the actuator may be oriented in a multitude of positions; the pylons and indexer may have other physical characteristics in shape rendering a universal design such as the lock cutouts of the reduced clearance pylon being open to the edge opposite the flange used in conjunction with other indexer(s) providing proper orientation; the design of the bellcranks could be combined to provide a universal bellcrank with an eight point hub cutout; the lock bezel could be of any shape and incorporate a logo and/or a design to provide anti-wrenching; the OEM's locking hardware and/or the bellcrank could be secured to the hub, be it threaded, by a lock washer and nut in lieu of the keeper; the control receiver/transmitter could be one of any type electronic recognition device available and could incorporate a security system or alarm device; the system may be packaged, as to include the components, sub-assemblies and assemblies of any one of a multitude of embodiments, and offered to users of storage devices as an add-on kit as well as well as supplied to OEMs in a reduced cost, model specific, bulk form; the cap, shroud, feedthru, grommet and conduit might be eliminated in a concealed application where the protection of the actuator and wiring is unessential, etc.

Thus the scope of the invention should be determined by the appended claims and their legal equivalents, rather than by the examples given.

I claim:

1. For use with storage devices having locking hardware manipulated radially about the center axis of a keyed locking device, an improved remote entry locking system comprising, a keyed lock assembly, a free rotating lock cam hub, a first means joining said hub to said lock, a second means connecting rotational movement of said lock to said hub thereby conversely limiting independent free rotation thereof with said key withdrawn from said lock, an electromechanical actuator, a third means disposing said actuator to said lock, a fourth means connecting said actuator to said hub thereby transforming linear movement of said actuator to rotational movement of said hub, an electronic recognition control device, an electrical source, a fifth means electrically connecting said source to said control and said actuator, a sixth means keylessly activating said control thereby effecting linear movement of said actuator, whereby with said hardware attached to said hub said storage device may be locked and unlocked by use of either said control or said key.

2. The lock of claim 1 wherein is of the standard multifunction cam cylinder lock type.

3. The lock of claim 1 wherein is modified having removed its cam stop land.

4. The lock of claim 1 wherein having a concentric spindle.

5. The lock of claim 1 wherein having a cam stop affixed about thereby rotating with said spindle.

6. The hub of claim 1 wherein having an internally threaded axis.

7. The hub of claim 1 wherein having at one end a flatted cylindrical boss thereby accommodating said hardware and a flange at the opposite end each concentric to said axis.

8. The hub of claim 1 wherein having a cylindrical bore through said flange parallel to said axis.

9. The first means of claim 1, further including an axle threaded into and between said hub and said lock.

10. The second means of claim 1, further including a roll pin disposed within said hub and engaging said lock.

11. The third means of claim 1, further including a pylon disposing said actuator relative to said lock, thereby relative to said storage device.

12. The fourth means of claim 1, further including in combination a bellcrank and a shifter connected to and between said hub and said actuator.

13. The fifth means of claim 1, further including common electrical wiring and associated devices conventionally applied to said source, said control and said actuator.

14. The sixth means of claim 1, further including a device providing an electronic identity receivable and recognizable by said control.
